(19) United States
(12) Patent Application Publication
(10) Pub. No.: US 2020/0055771 A1
(43) Pub. Date: Feb. 20, 2020

(54) FILM-ATTACHED GLASS SUBSTRATE, ARTICLE, AND METHOD FOR PRODUCING FILM-ATTACHED GLASS SUBSTRATE

(71) Applicant: AGC Inc., Chiyoda-ku (JP)

(72) Inventors: Yosuke TAKEDA, Tokyo (JP); Toru IKEDA, Tokyo (JP); Naofumi AOYAMA, Tokyo (JP); Tatsuya MIYAJIMA, Tokyo (JP); Yoichi SERA, Tokyo (JP)

(73) Assignee: AGC Inc., Chiyoda-ku (JP)

(21) Appl. No.: 16/663,534

(22) Filed: Oct. 25, 2019

Related U.S. Application Data
(63) Continuation of application No. PCT/JP2018/016685, filed on Apr. 24, 2018.

(30) Foreign Application Priority Data
Apr. 28, 2017 (JP) 2017-089543

(51) Int. Cl. C03C 17/25; C03C 17/34

(52) U.S. Cl. CPC C03C 17/25; C03C 23/007; C03C 2217/213; C03C 17/3482

(57) ABSTRACT

The present invention relates to a film-attached glass substrate, characterized by: being provided with a glass substrate having two primary surfaces each having a compressive stress layer, and a film containing 1 at % or more of K disposed on one of the primary surfaces of the glass substrate; and the ratio of the difference in the amount of K in the compressive stress layer between the primary surfaces, the ratio being represented by formula (1), being −0.027 to 0.027. Formula (1): Ratio of difference in amount of K of compressive stress layer between primary surfaces=(amount of K in first primary surface−amount of K in second primary surface)/[(amount of K in first primary surface+amount of K in second primary surface)/2]

### TECHNICAL FIELD

The present invention relates to a film-attached glass substrate, an article, and a manufacturing method of a film-attached glass substrate.

### BACKGROUND ART

Conventionally, a glass substrate may be subjected to surface treatment to adjust its antiglareness, reflectivity, or conductivity.

Among processing methods are one in which as disclosed in Patent document 1 antiglare treatment is performed by etching the surface of a glass substrate.

Another method is known in which a function film such as an antiglare film, a low reflection film, a conductive film, or the like is formed on the surface of a glass substrate.

On the other hand, strengthening of a glass substrate by chemical strengthening has been also conducted. In chemical strengthening, a glass substrate is immersed in a molten salt that is kept lower than or equal to a strain point temperature of the glass, whereby ions such as Na ions in a surface layer of the glass substrate are replaced by ions having a larger ion radius such as K ions. As a result, a compressive stress layer is formed in the surface layer of the glass substrate, whereby the glass substrate is made more resistant to scratching and impact.

Where chemical strengthening is performed after formation of a functional film, there may occur a situation that the functional film obstructs ion exchange. As a result, the surface on the side on which the functional film is formed is not strengthened sufficiently.

One countermeasure is a method of forming a functional film after chemical strengthening. However, where a functional film is formed after chemical strengthening, relaxation may occur in a compressive stress layer due to temperature increase, depending on the functional film baking temperature, resulting in reduction of the compressive stress.

In connection with the above, the following documents disclose methods in which chemical strengthening is performed after formation of a functional film through which ions permeate.

Patent document 2 states that when a tin oxide conductive film is formed on the surface of a glass substrate, chemical strengthening can be performed after the film formation.

Patent document 3 states that when a film made of an inorganic substance whose H atom concentration is in a range of 1.0×10¹⁵ to 1.0×10¹⁹ atoms/mm³ is formed as a functional film on the surface of a glass substrate, chemical strengthening can be performed after the film formation.

Patent document 4 states that when a functional film is formed by applying a coating liquid containing a silica precursor such as alkoxysilane and hollow silica sol to a glass substrate and drying it, chemical strengthening can be performed after the film formation. This method is simple because a film can be formed only by applying, drying, and baking. Furthermore, this method is useful in that the performance of a functional film can be controlled by the composition of a coating liquid and an applying method. For example, a low reflection film is formed by mixing a material having a small refractive index into a coating liquid. Also, an antiglare film is formed by applying a coating liquid such that projections and recesses are formed on the surface.

Patent document 5 states that when a functional film is formed on the surface of a glass substrate by applying, to the glass substrate, a silica precursor including a silane compound having a hydrolyzable group bonded to a silicon atom and a hydrolytic condensate and drying it, chemical strengthening can be performed after the film formation. The phrase “hydrolyzable group bonded to a silicon atom” means a group that can be converted into an OH group bonded to a silicon atom by hydrolysis.

### CITATION LIST

### Patent Document

Patent document 1: JP-T-2013-544226 (The symbol “JP-T” as used herein means a published Japanese translation of a PCT patent application.)

Patent document 2: JP-A-H4-310544

Patent document 3: WO 2013/094479

Patent document 4: JP-A-2011-88765

Patent document 5: WO 2015/186753

### SUMMARY OF INVENTION

### Technical Problem

The techniques disclosed in Patent documents 2-5 are superior in that chemical strengthening can be performed after formation of a functional film.

However, even the techniques disclosed in Patent documents 2-5 are associated with a problem that since a difference in ion permeation rate exists between the surface on which the functional film is formed and the surface on which the functional film is not formed, the chemical strengthening causes a difference in the depth of a compressive stress layer or the compressive stress value, possibly resulting in a warp of the glass substrate.

The present invention has been made in view of the above problems, and an object of the present invention is therefore to provide a film-attached glass substrate whose warp is suppressed even in a case that chemical strengthening is performed after formation of a functional film as well as a related article and manufacturing method of the film-attached glass substrate.

### Solution to Problem

A film-attached glass substrate of the present invention includes:

a glass substrate including two main surfaces each including a compressive stress layer; and

a film that is formed on one of the two main surfaces of the glass substrate and includes 1 at % or larger of K, in which

the two main surfaces have a K amount difference ratio of the compressive stress layers of the main surfaces, that is given by Relation (1) shown below, being in a range of −0.027 to 0.027:

(K amount difference ratio of compressive stress layers of main surfaces)={(K amount of first main surface)−(K amount of second main surface)}/[{(K amount of first main surface)+(K amount of second main surface)}/2] (1),

in which the first main surface is a main surface on which the film is formed, the second main surface is a main surface on which the film is not formed, and the K amount means a value obtained by subtracting, from a value obtained by accumulating K counts, in a thickness direction, of a layer having a certain thickness including the compressive stress layer using an EPMA (electron probe microanalyzer), a value obtained by accumulating K counts of a portion that has a same thickness as the layer having the certain thickness including the compressive stress layer and has no compressive stress layer formed therein.

In the present invention, since the K amount difference ratio of the compressive stress layers of the main surfaces is in the range of −0.027 to 0.027, the difference of the depths of the compressive stress layers and the difference of the compressive stress values between the two main surfaces are small. As a result, a warp of the glass substrate can be suppressed even in the case where chemical strengthening is performed after formation of a functional film.

In the film-attached glass substrate according to the present invention, it is preferable that the two main surfaces have the K amount difference ratio of the compressive stress layers of the main surfaces given by Relation (1) being in a range of −0.02 to 0.02.

In this mode of the present invention, since the K amount difference ratio of the compressive stress layers of the main surfaces is in the range of −0.02 to 0.02, the difference of the depths of the compressive stress layers and the difference of the compressive stress values between the two main surfaces are reduced further. As a result, a warp of the glass substrate can be suppressed even in the case where chemical strengthening is performed after formation of a functional film.

In the film-attached glass substrate according to the present invention, it is preferable that the film includes a silica-based matrix including 50 mass % or larger of a silica.

In this mode of the present invention, since the film includes a silica-based matrix, ions can permeate the film during chemical strengthening. As a result, a warp of the glass substrate can be suppressed even in the case where chemical strengthening is performed after formation of a functional film.

An article according to the present invention includes one of the above film-attached glass substrate.

In the present invention, the article includes a film-attached glass substrate in which the warp of the glass substrate is suppressed even in the case where chemical strengthening is performed after formation of a functional film. As a result, the strength of the article is increased and its dimensional accuracy in a state of including the glass substrate is increased.

A method for manufacturing a film-attached glass substrate of the present invention includes steps of:

applying a coating liquid to one of two main surfaces of a glass substrate; and

obtaining a film-attached glass substrate by chemically strengthening the glass substrate to which the coating liquid has been applied, in which

the coating liquid includes, at a proportion that satisfies Relation (2) shown below, a silica precursor (A) including a silane compound excluding a trialkoxysilane having an alkyl group having a carbon number of 3 or larger and 10 or smaller, and/or including a hydrolytic condensate thereof, and a silica precursor (B) including a trialkoxysilane having an alkyl group having a carbon number of 3 or larger and 10 or smaller, and/or including a hydrolytic condensate thereof, and

a sum of a content of the silica precursor (A) and a content of the silica precursor (B) in terms of an SiO₂-converted concentration with respect to a content of solids in terms of oxides in the coating liquid is 50 mass % or larger:

(silica precursor (B) (mol))/{(silica precursor (A) (mol))+(silica precursor (B) (mol))}≥0.3 (2).

In the present invention, since a film is formed on a non-strengthened glass substrate by applying a coating liquid that includes the silica precursor (A) and the silica precursor (B) in the range satisfying Relation (2), ions can easily permeate the film during chemical strengthening.

As a result, a warp of the glass substrate can be suppressed even in the case where chemical strengthening is performed after formation of a functional film.

Furthermore, in the present invention, since chemical strengthening is performed after the coating liquid is applied and dried, the coating liquid is heated by a strengthening liquid and the film is thermally cured.

As a result, baking of the coating liquid is not always necessary, which means high productivity.

In the present invention, it is preferable that the silica precursor (A) is a tetraalkoxysilane and/or a hydrolytic condensate thereof.

In this mode of the present invention, since tetraalkoxysilane having well balanced stability and the ease of hydrolysis is used as the silica precursor (A), film formation is made easier.

In the present invention, it is preferable that the silica precursor (A) is at least one substance selected from the group consisting of a tetramethoxysilane, a tetraethoxysilane, a tetrapropoxysilane, a tetrabuthoxysilane, and their hydrolytic condensates.

In this mode of the present invention, since tetraalkoxysilane is used as the silica precursor (A), the wear resistance of the film can be increased.

In the present invention, it is preferable that the silica precursor (B) is at least one substance selected from the group consisting of a propyltrimethoxysilane, a propyltriethoxysilane, a hexyltrimethoxysilane, an octyltriethoxysilane, a decyltrimethoxysilane, and their hydrolytic condensates.

In this mode of the present invention, since trialkoxysilane exemplified above which can be obtained easily is used as the silica precursor (B), high productivity is attained.

### BRIEF DESCRIPTION OF DRAWINGS

FIG. 1 is a sectional view of a film-attached glass substrate according to an embodiment of the present invention.

FIG. 2 is a graph showing a relationship between the PTMS content ratio and the warp after chemical strengthening.

FIG. 3 is a graph showing a relationship between the K amount difference ratio of compressive stress layers of the main surfaces (hereinafter also referred to as a “K amount difference ratio of the main surfaces”) and the warp after chemical strengthening.

FIG. 4 is a graph showing a relationship between the PTMS content ratio and the K amount difference ratio of the main surfaces.

### DESCRIPTION OF EMBODIMENT

The following definitions of terms apply to the specification body.

The chemical strengthening method is one of methods for forming a compressive stress layer in a surface layer of a glass substrate, more specifically, a method for replacing ions (e.g., Na ions) in a surface layer of a glass substrate with ions (e.g., K ions) having a larger ion radius by immersing the glass substrate in a molten salt that is kept lower than or equal to a strain point temperature of the glass. As a result, compressive stress generates in a surface layer of the glass substrate. The strain point of the glass is lower than its softening temperature.

The “compressive stress layer” is a layer (chemically strengthened layer) having desired surface compressive stress.

A thickness of a compressive stress layer is measured by a surface stress meter (e.g., FSM-6000LE produced by Orihara Manufacturing Co., Ltd).

The “silica precursor” is a substance that can form a matrix having silica as the main component.

The “content of solids in terms of oxides” means the sum of contents, in terms of oxides (in terms of metal oxides), of components including a metal element among components contained in a coating liquid.

The content that is given as a ratio with respect to a content of solids in terms of oxides is a content in terms of oxides. For example, a content of a silica precursor is an SiO₂-converted content, more specifically, a content that is obtained when all Si atoms contained in the silica precursor are changed to SiO₂.

### (Film-Attached Glass Substrate 1)

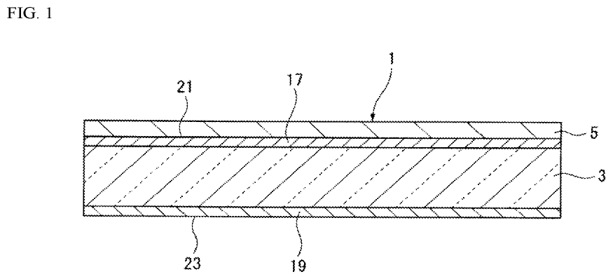

FIG. 1 is a sectional view schematically showing an example of film-attached glass substrate 1 according to the present invention.

This example of the film-attached glass substrate 1 has a glass substrate 3 and a film 5.

### (Glass Substrate 3)

The glass substrate 3, which is made of a chemically strengthened glass, has a main surface 21 having a compressive stress layer 17 and a main surface 23 having a compressive stress layer 19.

The thickness of the glass substrate 3 is preferably 5 mm or smaller, even preferably 0.33 mm or larger and 2 mm or smaller, and particularly preferably 0.7 mm or larger and 1.1 mm or smaller.

It is difficult to strengthen the glass substrate 3 whose thickness is 2 mm or smaller by a wind cooling strengthening method. Thus, the present invention is very useful when applied to a case that the thickness of the glass substrate 3 is 2 mm or smaller. As the glass substrate 3 becomes thinner, its light absorption is lowered and hence it becomes more suitable for uses in which its transmittance should be high. As the glass substrate 3 becomes thinner, the mass of the film-attached glass substrate 1 per unit area becomes smaller and hence an article including the film-attached glass substrate 1 can be made lighter.

When the thickness of the glass substrate 3 is 0.33 mm or larger, the film-attached glass substrate 1 is small in warp and hence is easy to handle even if it is large (e.g., its longer side is 300 mm or longer).

It is preferable that the surface compressive stress of the glass substrate 3 is 400 MPa or larger and the thickness of each of the compressive stress layers 17 and 19 is 5 μm or larger. When the surface compressive stress is 400 MPa or larger and the thickness of each of the compressive stress layers 17 and 19 is 5 μm or larger, the glass substrate 3 is superior in the resistance to physical impact such as scratching.

For certain uses, the surface compressive stress of the glass substrate 3 is preferably 500 MPa or larger, even preferably 600 MPa or larger. Typically, the surface compressive stress is 800 MPa or larger.

The “K amount difference ratio of main surfaces” of the compressive stress layers 17 and 19 of the main surfaces 21 and 23 of the glass substrate 3 which is given by the following Relation (1) is in a range of −0.027 to 0.027.

(K amount difference ratio of main surfaces)={(K amount of first main surface)−(K amount of second main surface)}/[{(K amount of first main surface)+(K amount of second main surface)}/2] (1)

The first main surface means the main surface 21 located on the side where the film 5 is formed and the second main surface means the main surface 23 located on the side where the film 5 is not formed. The K amount means a value obtained by subtracting, from a value obtained by accumulating K counts, in the thickness direction, of a layer having a prescribed thickness including a compressive stress layer using an EPMA, a value obtained by accumulating K counts of a portion that has the same thickness as the layer having the prescribed thickness including the compressive stress layer and in which no compressive stress layer is formed.

Setting the K amount difference ratio of main surfaces in the range of −0.027 to 0.027 makes it possible to suppress a warp of the glass substrate 3.

The K amount difference ratio of main surfaces is preferably in a range of −0.02 to 0.02, even preferably in a range of −0.016 to 0.016, and further preferably in a range of −0.015 to 0.015.

When the K amount difference ratio of main surfaces is set in the range of −0.02 to 0.02, a warp of the glass substrate 3 can be suppressed further.

When the K amount difference ratio of main surfaces is set in the range of −0.016 to 0.016, a fingerprint is not prone to be left, whereby a normal film surface can be obtained. When the K amount difference ratio of main surfaces is set in the range of −0.015 to 0.015, clarity (resolution index value C; described later in detail) is also made improved.

Conditions of the glass substrate 3 before chemical strengthening will be described in a manufacturing method section.

### (Film 5)

The film 5 is formed on at least one of the main surfaces 21 and 23 of the glass substrate 3; in FIG. 1, formed on the main surface 21. The film 5 may be formed on either part of or the whole of the main surface 21. The film 5 is a functional film for imparting any of functions such as antiglareness, low reflectance, scratch resistance, and antifoulingness to the glass substrate 3.

The film 5 is formed by applying a coating liquid including a silica precursor (A) and a silica precursor (B) to the glass substrate, drying it, and then performing chemical strengthening thereto.

Since the film 5 has a hydrolytic condensate of the silica precursor (A) or (B) as its framework, it includes a matrix (silica-based matrix) having silica as the main component.

It is preferable that the silica-based matrix includes 50 mass % or more of silica in the matrix.

Since the silica-based matrix may include a component(s) other than silica, the film 5 includes a component(s) other than silica. An example of the component(s) is one or plural ions or compounds such as oxides of elements selected from the group consisting of Li, B, C, N, F, Na, Mg, Al, P, S, K, Ca, Ti, V, Cr, Mn, Fe, Co, Ni, Cu, Zn, Ga, Sr, Y, Zr, Nb, Ru, Pd, Ag, In, Sn, Hf, Ta, W, Pt, Au, Bi, and lanthanoid elements.

The film 5 includes 1 at % or more of potassium (K) among the components. This is because the film 5 is a film through which K ions permeate.

The film 5 may either include only the silica-based matrix or include another or other components further. For example, the film 5 may include particles that are dispersed in the silica-based matrix.

There are no particular limitations on the film 5 as long as it can be thermally cured by performing chemical strengthening, after applying, on the glass substrate, a coating liquid including the silica precursor (A) and the silica precursor (B) at respective proportions that satisfy Relation (2) and drying it. Examples of the film 5 include an antiglare film, a low reflection film, an anti-weathering film, an alkali barrier film, a scratch preventive film, or an antifouling film. It is preferable that the film 5 is an antiglare film or a low reflection film in terms of their high necessity in uses of chemically strengthened glass substrates.

(Silica precursor (B) (mol))/{(silica precursor (A) (mol))+(silica precursor (B) (mol))}≥0.3 (2)

Where the film 5 is an antiglare film, the 60° specular glossiness of its surface is preferably 130% or lower, even preferably 120% or lower, further preferably 80% or lower, and particularly preferably 60% or lower. When the 60° specular glossiness of the surface of the film 5 is 130% or lower, it exhibits a sufficient antiglare effect.

Where the film 5 is an antiglare film, the arithmetic mean roughness Ra of the surface of the film 5 is preferably in a range of 0.01 to 1 μm, even preferably in a range of 0.02 to 1 μm, and further preferably in a range of 0.02 to 0.8 μm. When Ra is 0.01 μm or larger, the film 5 exhibits a sufficient antiglare effect. When Ra is 1 μm or smaller, in the case where the film-attached glass substrate 1 is installed in an image display device as a protective sheet or any of various filters, contrast reduction of an image can be suppressed sufficiently.

Where the film 5 is a low reflection antiglare film, the refractive index of the film 5 is preferably in a range of 1.23 to 1.47, even preferably in a range of 1.25 to 1.40. If the refractive index of the film 5 is 1.47 or smaller, the surface reflection is suppressed and the light transmittance is made larger than in the case of the glass substrate 3 itself. When the refractive index of the film 5 is 1.23 or larger, the film 5 is dense and hence is superior in mechanical strength such as wear resistance and in the adhesion to the glass substrate 3.

When the film-attached glass substrate 1 is installed in a solar cell on its light incidence side as a cover glass, the power generation efficiency of the solar cell is increased.

Where the film 5 is a low reflection film, the thickness of the film 5 is preferably in a range of 30 to 300 nm, even preferably in a range of 40 to 200 nm. Where the film thickness is 30 nm or larger, light interference occurs and a low reflection property appears. When the film thickness is 300 nm or smaller, the film 5 can be formed without occurrence of cracks.

A film thickness is determined from reflectance measured by a spectral photometer.

Where the film 5 is a low reflection film, its reflectance is preferably 2.6% or smaller in terms of a smallest value (what is called bottom reflectance) in a wavelength range of 300 to 1,200 nm, even preferably 1% or smaller.

A portion having the film 5 (hereinafter also referred to as a “functional film surface”) has the wear resistance such that the difference of 60° specular glossiness values between before and after a wear resistance test is preferably 60 or smaller, even preferably 55 or smaller, and further preferably 50 or smaller. The wear resistance test is carried out using a wear resistance tester (hereinafter also referred to as a “rubbing tester”) capable of reciprocation under a constant load in which a friction block such as an eraser, steel wool member, or a felt member is attached to its tip. Measurement of 60° specular glossiness is carried out according to JIS Z8741: 1997 in such a manner that no influence of reflection light coming from the surface opposite to the film surface of the glass substrate is received. As the degree of surface wear becomes higher, the component of specular reflection from the surface with respect to incident light having a prescribed incident angle increases. Thus, a smaller change of 60° specular glossiness value means higher wear resistance.

In particular, to suppress physical deterioration caused by contact of articles and obtain a film that is superior in long-term durability, the film 5 has the wear resistance such that the difference of 60° specular glossiness values between before and after the wear resistance test is preferably 20 or smaller, even preferably 15 or smaller, and further preferably 10 or smaller.

It is most preferable that the difference of 60° specular glossiness values between before and after the wear resistance test is substantially equal to zero.

### <Manufacturing Method of Film-Attached Glass Substrate>

For example, the film-attached glass substrate 1 can be manufactured by forming a film 5 by applying a coating liquid on a glass substrate 3 before chemical strengthening, drying the glass substrate 3 to which the coating liquid has been applied, and chemically strengthening the glass substrate 3 on which the film 5 is formed.

If necessary, known post treatment may be performed on the film-attached glass substrate 1 after the chemical strengthening.

In the case where the film-attached glass substrate 1 is a mode in which the film 5 is formed on a part of the glass substrate 3, the film 5 may be formed, for example, after masking that portion of the surface of the glass substrate 3 in which the film 5 should not be formed.

### (Coating Liquid)

The coating liquid includes: a silica precursor (A) including a silane compound excluding a trialkoxysilane having an alkyl group having a carbon number of 3 or larger and 10 or smaller, and/or including a hydrolytic condensate thereof; a silica precursor (B) including a trialkoxysilane having an alkyl group having a carbon number of 3 or larger and 10 or smaller, and/or including a hydrolytic condensate thereof; and a liquid medium. As necessary, the coating liquid may contain particles, an additive, or the like.

### Silica Precursor (A):

The silica precursor (A) includes a silane compound excluding a trialkoxysilane having an alkyl group having a carbon number of 3 or larger and 10 or smaller, and/or includes a hydrolytic condensate thereof, and the hydrolytic condensate constitutes the framework of the silica-based matrix.

Alkoxysilane having well-balanced stability and the ease of hydrolysis is preferable as the silica precursor (A).

Examples of alkoxysilane include alkoxysilane having an alkyl group (e.g., methyltrimethoxysilane or ethyltriethoxysilane), alkoxysilane having a vinyl group (e.g., vinyltrimethoxysilane or vinyltriethoxysilane), alkoxysilane having an epoxy group (e.g., 2-(3, 4-epoxycyclohexyl)ethyltrimethoxylsilane, 3-glycidoxypropyltrimethoxylsilane, 3-glycidoxypropylmetyldiethoxylsilane, or 3-glycidoxypropyltriethoxysilane), and alkoxysilane having an acryloyloxy group (e.g., 3-acryloyloxypropyltrimethoxysilane).

Other examples of alkoxysilane include tetramethoxysilane, tetraethoxysilane, tetrapropoxysilane, tetrabuthoxysilane, perfluoropolyether triethoxysilane, and perfluoroethyltriethoxysilane.

Among the above examples, tetraalkoxysilane such as tetramethoxysilane, tetraethoxysilane, tetrapropoxysilane, or tetrabuthoxysilane and/or its hydrolytic condensate is preferable. Tetraethoxysilane and tetramethoxysilane are most preferable from the practical viewpoints of the ease of handling and the ease of obtaining.

The silica precursor (A) may be either one of the above substances or a combination of two or more of the above substances.

### Silica Precursor (B):

Not only does a hydrolytic condensate in the silica precursor (B) serves as the framework of the silica-based matrix, but also the silica precursor (B) increases the ion permeability of the film 5 as a result of burning of alkyl bases during preliminary heating that is performed before chemical strengthening, and prevents warp of a glass.

To increase the ion permeability, the silica precursor (B) includes a trialkoxysilane having an alkyl group having a carbon number of 3 or larger and 10 or smaller, and/or includes a hydrolytic condensate thereof.

Examples of the silica precursor (B) include propyltrimethoxysilane (PTMS), propyltriethoxysilane, hexyltrimethoxysilane, octyltriethoxysilane, or decyltrimethoxysilane and/or their hydrolytic condensate.

The silica precursor (B) may be either one of the above substances or a combination of two or more of the above substances.

The hydrolysis and condensation of the silica precursor (A) and the silica precursor (B) can be performed by known methods.

For example, where the silica precursor (A) is tetraalkoxysilane, its hydrolysis and condensation are performed using water whose amount is four times in mole or more of the amount of the tetraalkoxysilane and an acid or an alkali that serves as a catalyst.

Examples of the acid include an inorganic acid (e.g., HNO₃, H₂SO₄, or HCl), and an organic acid (e.g., formic acid, oxalic acid, monochloroacetic acid, dichloroacetic acid, or trichloroacetic acid). Examples of the alkali include ammonia, sodium hydroxide, and potassium hydroxide. A preferable example of the catalyst is an acid from the viewpoint of long-term storage of the hydrolytic condensate in each of the silica precursor (A) and the silica precursor (B).

### Liquid Medium:

The liquid medium serves to dissolve or disperse the silica precursor (A) and the silica precursor (B), and it is preferable that the liquid medium is a solvent capable of dissolving the silica precursor (A) and the silica precursor (B). Where the coating liquid contains particles, the liquid medium may be one having a function of a dispersant for dispersing the particles.

Examples of the liquid medium include water, alcohol, ketone, ether, cellosolve, ester, glycol ether, a nitrogen-containing compound, and a sulfur-containing compound.

Examples of alcohol include methanol, ethanol, isopropanol, 1-butanol, 2-butanol, isobutanol, and diacetone alcohol.

Examples of ketone include acetone, methylethylketone, and methylisobutylketone.

Examples of ether include tetrahydrofuran and 1,4-dioxane.

Examples of cellosolve include methyl cellosolve and ethyl cellosolve.

Examples of ester include methyl acetate and ethyl acetate.

Examples of glycol ether include ethyleneglycol monoalkylether.

Examples of the nitrogen-containing compound include N, N-dimethylacetamide, N, N-dimethylformamide, and N-methylpyrrolidone.

Examples of the sulfur-containing compound include dimetylsulfoxide.

The liquid medium may be either one of the above substances or a combination of two or more of the above substances.

Since water is necessary for hydrolysis of each of the silica precursor (A) and the silica precursor (B), the liquid medium contains at least water unless the liquid medium is subjected to substitution after hydrolysis.

In this connection, the liquid medium may be either water or a mixed liquid of water and another liquid. Examples of the other liquid include alcohol, ketone, ether, cellosolve, ester, glycol ether, a nitrogen-containing compound, and a sulfur-containing compound. Among the above other liquid, alcohol is a preferable example of a solvent for each of the silica precursor (A) and the silica precursor (B). Particularly preferable examples thereof are methanol, ethanol, isopropanol, 1-butanol, 2-butanol, and isobutanol.

The liquid medium may contain an acid or an alkali. The acid or alkali may be either one that is added as a catalyst for hydrolysis or condensation of a material (e.g., alkoxysilane) at the time of preparation of a solution of the silica precursors or one that is added after preparation of a solution of the silica precursor (A) and the silica precursor (B).

### Particles:

Where the coating liquid contains particles, the characteristics (e.g., refractive index, transmittance, reflectance, hue, conductivity, wettability, physical durability, and chemical durability) of the film 5 can be adjusted by kinds of the particles and blending quantity of the particles.

Examples of the particles include organic particles and inorganic particles.

Example materials of the inorganic particles include a metal oxide, a metal, an alloy, and an inorganic pigment.

Examples of the metal oxide include Al₂O₃, SiO₂, SnO₂, TiO₂, ZrO₂, ZnO, CeO₂, Sb-containing SnOₓ (ATO), Sn-containing In₂O₃(ITO), and RuO₂.

Example shapes of the particles include a sphere, an ellipse, a needle-like shape, a plate-like shape, a rod-like shape, a cone, a cylinder, a cube, a cuboid, a diamond-like shape, a star-like shape, and an indefinite shape.

The particles maybe any of solid particles, hollow particles, and particles with holes such as porous particles. The term “solid” means absence of a cavity inside. The term “hollow” means presence of a cavity inside.

In particular, plate-like or scaly silica particles are preferable from the viewpoint of effectuation of antiglareness.

### Additive:

Any of various known additives can be used as the additive. Examples of the additive include a surfactant for increasing the leveling performance, a metal compound for increasing the durability of the film 5, an ultraviolet absorbing agent, an infrared reflection agent, an infrared absorbing agent, and an antireflection agent.

Examples of the surfactant include a silicone oil type surfactant and an acrylic type surfactant.

Preferable examples of the metal compound include a zirconium chelate compound, a titanium chelate compound, and an aluminum chelate compound. Examples of the zirconium chelate compound are zirconium tetraacetyl acetonate and zirconium tributoxystearate.

### Composition:

### Composition of Coating Liquid:

The coating liquid has a composition including the silica precursor (A) and the silica precursor (B) at respective proportions that satisfy the following Relation (2):

(Silica precursor (B) (mol))/{(silica precursor (A) (mol))+(silica precursor (B) (mol))}≥0.3 (2)

Satisfaction of the lower limit of Relation (2) makes it possible to increase the ion permeability of the film 5. The lower limit being 0.4 or larger is preferable because the ion permeability of the film 5 is increased further and the warp of the glass substrate 3 is suppressed.

It is preferable that the upper limit of Relation (2) is 0.8 or smaller because the silica-based matrix can be strengthened further. It is even preferable that the upper limit of Relation (2) is 0.6 or smaller because clarity can be increased.

The ratio of the sum of the content of the silica precursor (A) and the silica precursor (B) in the coating liquid with respect to the content of solids in terms of oxides in the coating liquid is, in SiO₂-converted concentration, 50 mass % or larger, more preferably 60 mass % or larger, further preferably 70 mass % or larger, and particularly preferably 80 mass % or more.

When the SiO₂-converted concentration thereof with respect to the content of solids in terms of oxides is 50 mass % or larger, sufficient strength of the adhesion between the glass substrate 3 and the film 5 can be obtained.

There are no particular limitations on the upper limit of the SiO₂-converted concentration thereof; it may be 100 mass %. The contents of the silica precursor (A) and the silica precursor (B) can be set as appropriate according to the contents of the other components that are added to the coating liquid as necessary.

The content of the liquid medium in the coating liquid is set according to the concentration of solid contents in the coating liquid.

The concentration of solid contents in the coating liquid is preferably 1 to 6 mass % of the entire amount (100 mass %) of the coating liquid, even preferably 2 to 5 mass %. When the concentration of solid contents is higher than or equal to the lower limit of the above range, the liquid amount of a coating liquid used for formation of the film 5 can be reduced. When the concentration of solid contents is lower than or equal to the upper limit of the above range, the uniformity of the film thickness of the film 5 is increased.

The concentration of solid contents in the coating liquid is the concentration of the sum of the contents of all components in the coating liquid other than the liquid medium. The content of a component containing a metal element is a value in terms of oxides.

Where the coating liquid contains solid inorganic particles, the content (in terms of oxides) of the solid inorganic particles in the coating liquid is preferably 50 mass % or smaller with respect to the content of solids in terms of oxides (100 mass %) in the coating liquid, even preferably 2 to 40 mass %, and particularly preferably 3 to 30 mass %. When the content of the solid inorganic particles is larger than or equal to the lower limit of the above range, the advantages of the addition of the solid inorganic particles appear satisfactorily. For example, where the solid inorganic particles are solid silica particles, the degree of surface undulation of the surface of the coated film is increased, whereby the light scattering property of the film 5 is increased to provide an antiglareness enhancing effect. When the content of the solid inorganic particles is smaller than or equal to the upper limit of the above range, the film 5 is superior in mechanical strength such as wear resistance.

The coating liquid may either contain or not contain hollow silica particles as the particles; the content (SiO₂-converted content) of the hollow silica particles in the coating liquid should be 50 mass % or smaller with respect to the content of solids in terms of oxides in the coating liquid. The content of hollow silica particles is preferably 40 mass % or smaller, even preferably 30 mass % or smaller.

The coating liquid can be prepared by preparing a solution in which silane precursors are dissolved in a liquid medium and mixing, as necessary, an additional liquid medium, a dispersing liquid of particles, other desired components, etc. into the solution.

### (Glass Substrate)

There are no particular limitations on the glass substrate 3 that has not been subjected to chemical strengthening yet (hereinafter referred to as a “non-strengthened glass substrate”) as long as it has a composition capable of being strengthened chemically; the non-strengthened glass substrate may have any of various compositions. For example, soda-lime glass, aluminosilicate glass, etc. can be used suitably. Aluminosilicate glass is preferable in terms of being chemically strengthened easily.

It is preferable that a glass substrate that can be chemically strengthened easily has a glass composition including, in mole percentages on oxide basis, 56 to 75% of SiO₂, 1 to 20% of Al₂O₃, 8 to 22% of Na₂O, 0 to 10% of K₂O, 0 to 14% of MgO, 0 to 5% of ZrO₂, and 0 to 10% of CaO.

It is preferable that a glass substrate that can be chemically strengthened easily has another glass composition including, in mole percentages on oxide basis, 60 to 75% of SiO₂, 2 to 25% of Al₂O₃, 10 to 20% of Na₂O, 0 to 7% of K₂O, 0 to 10% of MgO, and 0 to 15% of CaO.

It is preferable that a glass substrate that can be chemically strengthened easily has another glass composition including, in mole percentages on oxide basis, 50 to 74% of SiO₂, 2 to 8% of Al₂O₃, 8 to 18% of Na₂O, 0 to 8% of K₂O, 2 to 15% of MgO, 0 to 4% of ZrO₂, 0 to 10% of CaO, 0 to 3% of SrO, and 0 to 3% of BaO.

It is preferable that a glass substrate that can be chemically strengthened easily has another glass composition including, in mole percentages on oxide basis, 50 to 74% of SiO₂, 8 to 25% of Al₂O₃, 8 to 18% of Na₂O, 0 to 8% of K₂O, 2 to 15% of MgO, 0 to 4% of ZrO₂, 0 to 10% of CaO, 0 to 3% of SrO, and 0 to 3% of BaO.

For example, the phrase “including 0 to 10% of K₂O” means that K₂O is not indispensable and may be included up to 10%. The same is applied to MgO, ZrO₂, and CaO.

The thickness of the non-strengthened glass substrate is substantially the same as that of a strengthened glass substrate 3.

The non-strengthened glass substrate may be either a smooth glass substrate shaped by the float process or the like or a figured glass substrate having projections and recesses on its surface. And the non-strengthened glass substrate may be not only a flat glass substrate but also a curved glass substrate.

The non-strengthened glass substrate may be one on the market or one manufactured by a known manufacturing method.

For example, the non-strengthened glass substrate can be manufactured by preparing various materials to constitute glass, melting them by heating, uniformizing the resulting molten glass by degassing, stirring, or the like, shaping the resulting glass into a plate-like shape by the known float process, down draw process (e.g., fusion process), pressing process, or the like, cooling the resulting glass plate gradually, and cutting the glass plate into plates having desired dimensions. A glass ribbon may be used on a line during glass shaping by the float process or the down draw process.

### (Coating)

After selection of a glass substrate 3 and a coating liquid, the coating liquid described above is applied to the non-strengthened glass substrate and dried to form a film 5.

### Coating Method:

Example methods for applying the coating liquid include known wet coating methods (e.g., spin coating method, spray coating method, dip coating method, die coating method, curtain coating method, screen coating method, ink jetting method, flow coating method, gravure coating method, bar coating method, flexographic coating method, slit coating method, and roll coating method).

Where an antiglare film is formed as the film 5, a preferable method for applying a coating liquid is the spray method because it enables formation of sufficient undulation.

Example nozzles to be used in the spray method include a 2-fluid nozzle and a 1-fluid nozzle.

The particle diameter of droplets of a coating liquid discharged from the nozzle is usually in a range of 0.1 to 100 μm, and is preferably in a range of 1 to 50 μm. When the particle diameter of droplets is 1 μm or larger, undulation for providing a sufficient antiglare effect can be formed in a short time. When the particle diameter of droplets is 50 μm or smaller, undulation that is suitable for providing a sufficient antiglare effect can be formed easily.

The particle diameter of droplets is a Sauter mean diameter that is measured by a laser measuring instrument. The particle diameter of droplets can be adjusted as appropriate by, for example, selecting a proper type of nozzle or adjusting a spray pressure or a liquid flow rate. For example, in the case of a 2-fluid nozzle, droplets become smaller as the spray pressure increases and droplets become larger as the liquid flow rate increases.

Under fixed coating conditions, the arithmetic mean roughness Ra and the 60° specular glossiness of the surface of the film 5 formed can be adjusted by the coating time, that is, the number of coating surfaces (i.e., the number of times of overspraying) of the spray method. For example, the arithmetic mean roughness Ra of the surface of the film 5 is prone to increase and 60° specular glossiness thereof is prone to decrease (i.e., its antiglare effect is enhanced) as the number of coating surfaces is made larger.

The electrostatic coating method may be used as a method for applying a coating liquid to form an antiglare film as the film 5. An example coating method of the electrostatic coating method is a method in which a coating liquid is sprayed after being charged by using an electrostatic coating gun having a rotary atomizing head.

A preferable method for applying a coating liquid to form a low reflection film as the film 5 is the roll coating method because it can be applied a wide non-strengthened glass substrate, the conveyance speed of a non-strengthened glass substrate can be set relatively high, and the amount of necessary coating liquid is relatively small. The reverse roll coating method is even preferable because it enables formation of the film 5 that is uniform in thickness and can easily form a film 5 having a desired thickness that enables optical designing (i.e., it is superior in film thickness controllability). On the other hand, the die coating method and the ink jetting method are preferable from the viewpoint of appearance of a product.

The temperature of an atmosphere under which a coating liquid is applied is preferably room temperature to 50° C., even preferably room temperature to 40° C.

The temperature of the non-strengthened glass substrate at the time of application of a coating liquid may be either the same as or different from an atmosphere temperature.

Where an antiglare film is formed as the film 5, it is preferable to apply a coating liquid after heating the non-strengthened glass substrate to 30° C. to 90° C. in advance. When the temperature of the non-strengthened glass substrate is 30° C. or higher, the liquid medium is evaporated quickly and hence sufficient undulation can be formed easily. When the temperature of the non-strengthened glass substrate is 90° C. or lower, proper adhesion is obtained between the non-strengthened glass substrate and the film 5. Where the thickness of the non-strengthened glass substrate is 5 mm or smaller, temperature reduction of the non-strengthened glass substrate may be suppressed by disposing, under the non-strengthened glass substrate, a temperature keeping board whose temperature is set higher than or equal to the temperature of the non-strengthened glass substrate in advance.

The coating may be performed such that plural coating liquids having different compositions are applied to the non-strengthened glass substrate sequentially. In this manner, the film 5 having plural layers can be formed.

For example, the coating may be performed such that a coating liquid not containing particles is applied first and a coating liquid containing particles is applied thereafter. Alternatively, the coating may be performed such that a coating liquid containing particles is applied first and then a coating liquid is applied that contains particles having different kind and content from the particles contained in the first-applied coating liquid.

Where plural coating liquids are applied sequentially, after applying a first one of the plural coating liquids, the next coating liquid may be applied to an as-formed coated film immediately. Alternatively, the first coated film may be dried before application of the next coating liquid. In this case, the drying may be performed either such that the liquid medium in the coated film is removed completely, or such that a liquid medium remains in the coated film.

Where the glass substrate 3 was manufactured by the float process, the surface on which to form the film 5 may be either the surface that was in contact with molten tin (B surface) or the surface opposite to it (T surface).

However, in general, replacement by K ions less tends to occur with the B surface in chemical strengthening than with the T surface, that is, the B surface is more difficult to be strengthen chemically. Thus, there may occur a case that the film 5 is formed preferably on the T surface.

### (Drying)

The drying which is performed after the film is formed by applying the coating liquid to the non-strengthened glass substrate may be performed either by heating or a method other than heating, that is, natural drying, air drying, or the like.

Where the drying is performed by heating, coating and heating may be performed simultaneously by heating the non-strengthened glass substrate when the coating liquid is applied to it. Alternatively, a coated film may be heated after the coating liquid is applied to the non-strengthened glass substrate.

A preferable upper limit of the drying temperature is about 450° C.

There are no particular limitations on the lower limit of the drying temperature. The polymerization of the silane precursors proceeds to some extent even in the case of natural drying. Thus, if there are no limitations on the time, it is theoretically possible to set the drying temperature close to room temperature.

To secure sufficient drying conditions, the drying temperature is preferably 25° C. or higher, even preferably 30° C. or higher.

From the viewpoint of the efficiency of chemical strengthening, the drying temperature is preferably in a range of 25° C. to 400° C., particularly preferably in a range of 30° C. to 400° C.

Although the drying time depends on the drying temperature, a drying time range is typically about 0.5 to 30 minutes, and preferably 1 to 5 minutes.

### (Chemical Strengthening)

The non-strengthened glass substrate is subjected to a chemical strengthening after the film 5 is formed on the non-strengthened glass substrate by coating. As a result, the non-strengthened glass substrate turns to the glass substrate 3 and the film-attached glass substrate 1 is obtained.

The chemical strengthening can be performed by a known method.

For example, where the non-strengthened glass substrate contains Na₂O, a method is employed in which the non-strengthened glass substrate on which the film 5 is formed is immersed in a heated potassium nitrate (KNO₃) molten salt. In this method, Na ions in a surface layer of the non-strengthened glass substrate are replaced by K ions in the molten salt, whereby surface compressive stress is generated and compressive stress layers 17 and 19 are formed. The KNO₃ molten salt may contain, for example, NaNO₃ at about 5% in addition to KNO₃.

The chemical strengthening treatment conditions depend on the glass composition and the thickness of the non-strengthened glass substrate and other factors; typical conditions are that the non-strengthened glass substrate is immersed in a KNO₃ molten salt having a temperature in a range of 350° C. to 550° C. that is lower than or equal to a glass strain point temperature, for 2 to 20 hours. Preferable chemical strengthening treatment conditions are that the non-strengthened glass substrate is immersed in a KNO₃ molten salt having a temperature in a range of 350° C. to 500° C. for 2 to 16 hours, and even preferable chemical strengthening treatment conditions are that the non-strengthened glass substrate is immersed in a KNO₃ molten salt having a temperature in a range of 350° C. to 500° C. for 2 to 10 hours.

When the chemical strengthening is completed, the film-attached glass substrate 1 including the glass substrate 3 and the film 5 is obtained.

### (Functions and Advantages)

In the above-described film-attached glass substrate 1 according to the present invention, the differences of the depths and compressive stress values between the compressive stress layers 17 and 19 of the main surfaces 21 and 23 are small because the difference ratio of the potassium contents of the compressive stress layers 17 and 19 given by Relation (1) (K amount difference ratio of the main surfaces) is in a range of −0.027 to 0.027. As a result, the warp of the glass substrate 3 can be suppressed even in the case where chemical strengthening is performed after formation of the film 5.

In the film-attached glass substrate 1 according to the present invention, the differences of the depths and the compressive stress values between the compressive stress layers 17 and 19 of the main surfaces 21 and 23 are decreased further when the difference ratio of the potassium contents of the compressive stress layers 17 and 19 of the main surfaces 21 and 23 (K amount difference ratio of the main surfaces) is in a range of −0.02 to 0.02. As a result, the warp of the glass substrate 3 can be suppressed even in the case where chemical strengthening is performed after formation of the film 5.

In the film-attached glass substrate 1 according to the present invention, ions can permeate the film 5 during a chemical strengthening because the film 5 includes a silica-based matrix. As a result, the warp of the glass substrate 3 can be suppressed even in the case where chemical strengthening is performed after formation of the film 5.

In the film-attached glass substrate 1 according to the present invention, ions permeate the film 5 easily during a chemical strengthening because the film 5 is formed by applying a coating liquid including the silica precursor (A) and the silica precursor (B) in the range in which Relation (2) is satisfied.

As a result, the warp of the glass substrate 3 can be suppressed even in the case where chemical strengthening is performed after formation of the film 5.

In the present invention, since chemical strengthening is performed after a coating liquid is applied and dried, the coating liquid is heated by a strengthening liquid and the film 5 is thermally cured during the chemical strengthening.

As a result, the coating liquid need not always be baked, and thus the productivity can be increased.

In the present invention, the productivity is high in the case where alkoxysilane in which stability and the ease of hydrolysis are well balanced is used as the silica precursor (A). In particular, where tetraalkoxysilane is used, the wear resistance of the film 5 can be increased.

In the present invention, the productivity is high because trialkoxysilane which can be purchased easily is used as the silica precursor (B).

The film-attached glass substrate 1 that is obtained by the manufacturing method of the present invention can be used for various uses according to the kind of the film 5. Specific example of uses include vehicular transparent components (e.g., headlight cover, side mirror, front transparent substrate, side transparent substrate, rear transparent substrate, instrument panel surface, reflection mirror or combiner of head-up display (HUD)), meters, construction windows, show windows, displays (e.g., notebook personal computer, monitor, LCD, PDP, ELD, CRT, and PDA), LCD color filters, touch panel substrates, pickup lenses, optical lenses, lenses for glasses, camera components, video components, CCD cover substrates, optical fiber end surfaces, projector components, copier components, solar cell transparent substrates (e.g., cover glass), cellphone windows, backlight unit components (e.g., light guide plate and cold cathode tube), liquid crystal luminance increasing films, organic EL light-emitting element components, inorganic EL light-emitting element components, phosphor light-emitting element components, optical filters, optical component end surfaces, illumination lamps, illumination equipment covers, and amplifier laser light sources.

### <Article>

The article according to the present invention includes the above-described film-attached glass substrate 1.

The article according to the present invention may either include only the film-attached glass substrate 1, or further include a member(s) other than the film-attached glass substrate 1. The article according to the present invention may be one in which only a part of the glass substrate 3 is provided with the film 5.

Examples of the article according to the present invention include the ones that were mentioned above as uses of the film-attached glass substrate 1, devices having one or more of those examples, etc.

Examples of devices in which the film 5 is an antiglare film (may either exhibit or not exhibit low reflectance) or a low reflection film, include a solar cell module, a display device, and an illumination device.

A preferable solar cell module is a solar cell module including a solar cell and transparent substrates such as cover glasses provided on the front surface and the back surface, respectively, of the solar cell to protect it, in which the film-attached glass substrate 1 is used as at least one of the transparent substrates, preferably as the front-side transparent substrate.

Examples of the display device include a cellphone, a smartphone, a tablet terminal, and a car navigation device.

Examples of the illumination device include an organic EL (electroluminescence) illumination device, and an LED (light-emitting diode) illumination device.

In the present invention, even in the case where chemical strengthening is performed after formation of the film 5, the article includes a film-attached glass substrate 1 in which the warp of the glass substrate 3 is suppressed. As a result, the strength of the article is increased and its dimensional accuracy in a state that it incorporates the film-attached glass substrate 1 is increased.

### EXAMPLES

Although the present invention will be described below in detail using Examples, the present invention is not limited to the following disclosure.

Among the following Examples, Examples 1-4 are Working Examples and Examples 5-7 are Comparative Examples.

First, measuring methods and evaluation methods that are employed in each Example will be described below.

### (Measurement of K Amount)

AK amount in the film 5 is measured through measurement of K in the film in terms of at %. The film 5 was separated from the glass substrate 3 using a razor, stuck to a C tape (that satisfies the JCAAD 029 standard), and subjected to C coating to render it conductive. A K amount was measured as all oxides in a standard-less manner with an acceleration voltage 15 kV using a SEM-EDX (SEM: SU-6600 produced by Hitachi High-Technologies Corporation; EDX: Noran System 6 produced by Thermo Fischer Scientific K.K.).

AK amount of a main surface was determined from a count in the following manner. First, a sample was embedded in epoxy resin and a cross-section sample was obtained by polishing. A glass portion of the cross section was subjected to measurement using an EPMA (JXA-8500F produced by JEOL Ltd.). A line analysis was conducted at a 1-μm pitch by setting the acceleration voltage and the sample current at 15 kV and 30 nA, respectively. X-ray intensity of K was measured at a rate of 1,000 ms/point using a PETH as analyzing crystal.

A value (COUNT*μm) was calculated by subtracting a “cumulative value from 40 μm to 80 μm” from a “cumulative value from the surface to 40 μm” of an obtained K count profile of each surface of each sample. This measurement was carried out three times (n=3) and average value was determined as a K amount. This is because a depth at which the K amount was saturated to such a level that a calculation error would not cause any problem was set at 40 μm taking into consideration a depth target value of compressive stress layers 17 and 19 of a glass to be manufactured.

AK amount difference ratio of the main surfaces was calculated according to Relation (1).

### (Measurement of Warp)

A warp after chemical strengthening was measured using a slant incidence interference method flatness tester FT-17 manufactured by Nidek Co., Ltd. Measurement was performed in a central 60-mm square range of a 100-mm square sample and a value obtained by converting a measurement result into a 90-mm square size was employed as a warp.

When a warp of the 90-mm square size was larger than 100 μm and measurement using FT-17 was impossible, measurement was performed using a feeler gauge. In this case, a 100-mm square sample was put on a surface table with a convex surface down and a warp of the 90-mm square size was measured from each of the four corners using a feeler gauge having a thickness 0.05 mm that complies with a JIS standard.

A positive warp direction is defined as a case where the main surface 21 side is convex and a negative warp direction is defined as a case where the main surface 21 side is concave.

### (Measurement of Fingerprint)

Fingerprint measurement was carried out visually. After the film 5 was applied, the glass was handled by holding its edges by hands that are covered with gloves. The portion of the glass that the hand touched was observed.

### (Measurement of Haze)

A haze ratio (Hz (%)) of a film-attached glass substrate was measured by a method that is prescribed in JIS K7136: 2000 using a haze meter HR-100 produced by Murakami Color Research Laboratory.

### (60° Specular Glossiness)

Sixty degrees specular glossiness (60° gloss (%)) was measured as glossiness of a surface, having the film 5, of a film-attached glass substrate. Sixty degrees specular glossiness was measured on an approximately central portion of an antiglare layer by a method prescribed in a section of 60° specular glossiness in JIS Z8741: 1997 using a gloss meter MULTI GLOSS 268Plus produced by Konica Minolta, Inc. without removing a reflection at the back surface of the film-attached glass substrate.

### (Clarity)

Measurement of clarity was carried out according to the following procedure using a variable angle photometer GC5000L produced by Nippon Denshoku Industries Co., Ltd. Firstly, first light was emitted from a direction having an angle θ=0°±0.5° (hereinafter referred to as an “angle 0° direction”) where the angle θ=0° corresponds to the direction that is from the first main surface side of a film-attached glass substrate and parallel with the thickness direction of the film-attached glass substrate. The first light passed through the film-attached glass substrate. Transmission light through the second main surface was received and its luminance was measured as “luminance of 0° transmission light.”

Then a similar operation was performed while the angle θ of reception of light emitted from the second main surface was varied in a range of −30° to 30°. In this manner, a luminance distribution of light passing through the film-attached glass substrate and emitted from the second main surface was measured and summed up to obtain “luminance of all transmission light.”

Subsequently, clarity (resolution index value C) was calculated according to the following Relation (3):

Clarity (resolution index value C)=1−[{(luminance of all transmission light)−(luminance of 0° transmission light)}/(luminance of all transmission light)] (3)

It has been confirmed that the clarity (resolution index value C) correlates with a visual resolution judgment result of an observer and behaves similarly to the human visual sense.

For example, a film-attached glass substrate that exhibits a small resolution index value C (close to 0) is low in resolution and, conversely, a film-attached glass substrate that exhibits a large resolution index value C is high in resolution. As a result, the resolution index value C can be used as a quantitative index for judging resolution of a film-attached glass substrate.

### (Diffusion)

Diffusion was measured according to the following procedure using a variable angle photometer GC5000L produced by Nippon Denshoku Industries Co., Ltd.

First light was emitted from a direction having an angle θ=−45°±0.5° (hereinafter referred to as an “angle −45° direction”) where the angle θ=0° corresponds to the direction that is from the first main surface side of a film-attached glass substrate and parallel with the thickness direction of the film-attached glass substrate. The first light was reflected by the film-attached glass substrate. Fourty-five degrees reflection light reflected to a direction that forms an angle 45° with the first main surface was received and its luminance was measured as “luminance of 45° reflection light.”

Then a similar operation was performed while the angle θ of reception of light emitted from the first main surface was varied in a range of 5° to 85°. In this manner, a luminance distribution of light passing through the film-attached glass substrate and emitted from the second main surface was measured and summed up to obtain “luminance of all reflection light.”

Subsequently, diffusion (antiglareness index value D) was calculated according to the following Relation (4):

Diffusion (antiglareness index value D)={(luminance of all reflection light)−(luminance of 45° reflection light)}/(luminance of all reflection light) (4)

It has been confirmed that the diffusion (antiglareness index value D) correlates with a visual antiglareness judgment result of an observer and behaves similarly to the human visual sense. For example, a film-attached glass substrate that exhibits a small antiglareness index value D (close to 0) is low in antiglareness and, conversely, a film-attached glass substrate that exhibits a large antiglareness index value D is high in antiglareness. As a result, the antiglareness index value D can be used as a quantitative index for judging antiglareness of a film-attached glass substrate.

### (Measurement of Glare)

A film-attached glass substrate was put on the display surface of a liquid crystal display (iPhone4 produced by Apple Incorporated (pixel density: 326 ppi)) with its undulated surface up, and a glare index value S was measured using an EyeScale ISC-A produced by I System Corporation.

### (Pencil Hardness)

Measurement was carried out according to JIS K5600-5-4:1999.

Evaluation was made of the surface having the film 5. Presence or absence of a scratch formed by a pencil was judged by checking a reflection visually.

### (Surface Roughness)

As for surface roughness of an antiglare film, Ra was measured by a method described in JIS B0601: 2001 using a surface roughness meter (Surfcom (registered trademark) 1500DX produced by Tokyo Seimitsu Co., Ltd.).

The measuring methods and evaluation methods have been described above.

Next, manufacturing conditions of each Example will be described.

### Example 1

### (Glass Substrate)

A glass substrate (size: 100 mm×100 mm; thickness: 1.1 mm) that contains, in mole percentages on oxide basis, 64.4% of SiO₂, 8.0% of Al₂O₃, 12.5% of Na₂O, 4.0% of K₂O, 10.5% of MgO, 0.1% of CaO, 0.1% of SrO, 0.1% of BaO, and 0.5% of ZrO₂ was prepared as a non-strengthened glass substrate.

### (Preparation of Coating Liquid)

First, following materials were prepared:

Silica precursor (A): tetraethoxysilane (TEOS)

Silica precursor (B):

propyltrimethoxylsilane (PTMS) KBM3033 produced by Sin-Etsu Silicones

Solvent: Ethanol-based organic solvent “Solmix (registered trademark)” AP-11 produced by Japan Alcohol Trading Co., Ltd.

SiO₂-containing substance other than silica precursors (A) and (B): SLV liquid (a dispersion liquid obtained by cracking scaly silica particles Sunlovely LFS HN150 produced by AGC Si-Tec Co., Ltd. and dispersing resulting particles in water). An average particle diameter of the scaly silica particles in the SLV liquid: 175 nm, an average aspect ratio ((average particle diameter)/(average thickness)): 80, and the scaly silica particles (an SiO₂-converted concentration 5 mass %).

Subsequently, a silica precursor liquid (total mass: 100 g) was prepared by mixing the above materials according to the following procedure.

First, 78.1 g of AP-11 was prepared, and 0.0113 mol (SiO₂-converted mass: 0.68 g) of the silica precursor (A) and 0.0453 mol (SiO₂-converted mass: 2.72 g) of the silica precursor (B) were added while stirring was being made using a magnetic stirrer.

As a result, the following equation was obtained, (Silica precursor (B) (mol))/{(silica precursor (A) (mol))+(silica precursor (B) (mol))}=0.0453 mol/(0.0453 mol+0.0113 mol)=0.80. In Examples, this value is also referred to as a “PTMS content ratio.”

The SLV liquid was further added by 12 g and mixing was performed at 25° C. for 30 minutes.

Then 60 mass % of aqueous solution of nitric acid was added by 0.12 g and mixing was performed at 60° C. for 60 minutes.

An SiO₂-converted concentration of the scaly silica particles in the silica precursor liquid was 0.60 mass % as shown in the following calculation, 100×{(mass 12 g of SLV liquid)/(total mass 100 g of silica precursor liquid)}×0.05 (the SiO₂-converted concentration 5 mass %)=0.60 mass %.

The total SiO₂-converted concentration of the silica precursors (A) and (B) in the silica precursor liquid was 3.40 mass % as shown in the following calculation, 100×{(mass 0.68 g of silica precursor (A))+(mass 2.72 g of silica precursor (B))}/(total mass 100 g of silica precursor liquid)=3.40 mass %.

Only the scaly silica particles and the silica precursors (A) and (B) were the oxide solid contents of the silica precursor liquid. Thus, the total SiO₂-converted concentration of the silica precursors (A) and (B) with respect to the content of solids in terms of oxides of the silica coating liquid was 85 mass %, 100×3.40/(0.60+3.40)=85 mass %, that is, 50 mass % or larger. The SiO₂-converted concentration of the oxide solid contents was 4.00 mass %, 0.60+3.40=4.00 mass %.

A coating liquid was obtained by diluting this silica precursor liquid by AP-11 such that the SiO₂-converted concentration of the oxide solid contents became 1.00 mass %.

### (Film Formation)

An electrostatic coating device including an electrostatic coating gun (liquid electrostatic coater produced by Asahi Sunac Corporation) was prepared. The electrostatic coating gun used was a rotary atomization type automatic electrostatic gun (Sunbell, ESA120, cup diameter: 70 mm, produced by Asahi Sunac Corporation). To facilitate grounding of the glass substrate, a metal mesh tray was prepared as a conductive substrate.

### (Electrostatic Coating)

The temperature and the humidity in a coating booth of the electrostatic coating device were adjusted so as to fall within a range of 25° C.±1° C. and a range of 50%±10%, respectively.

A cleaned non-strengthened glass substrate that had been heated to 30° C.±3° C. in advance was put on a chain conveyor of the electrostatic coating device via a conductive substrate. After a coating liquid in a temperature range of 25° C.±1° C. was applied to the main surface 21 of the glass substrate 3 by the electrostatic coating method while the glass substrate 3 was conveyed at a constant speed by the chain conveyor, the coating liquid was dried at 450° C. in the air for 30 minutes, whereby a film 5 was formed. As for the coating conditions for the coating liquid, the coating liquid rate was 29 mL/min, the cup rotation speed was 35 krpm, the nozzle height was 245 mm, the voltage was 60 kV, the number of times of coating was 4, the shaving air pressure was 0.07 MPa. The coating liquid rate means a rate of supply of a coating liquid to the electrostatic coating gun. The cup rotation speed means a rotation speed of the rotary atomizing head. The nozzle height means a distance from the nozzle head of the electrostatic coating gun (the front end of the rotary atomizing head in the spraying direction of the coating liquid composition) to the non-strengthened glass substrate. The voltage means a voltage applied to the electrostatic coating gun. The number of times of coating means the number of times of conveyance of the non-strengthened glass substrate, that is, the number of times of coating of the coating liquid composition by making the glass substrate 3 pass under the electrostatic coating gun. The shaving air is gas that was blown in such a manner as to surround the non-strengthened glass substrate like a hollow cylinder and thereby preventing the coating liquid from scattering to outside a coating range. The pressure means its gas pressure.

### (Chemical Strengthening)

The non-strengthened glass substrate that had been subjected to the electrostatic coating was subjected to ultrasonic cleaning in pure water, air-dried, processed at 420° C. for 120 minutes in a pre-heating furnace, and then immersed in a molten KNO₃ bath of 420° C. for 150 minutes. The glass substrate was thereafter taken out, cooled at room temperature for 60 minutes, subjected to ultrasonic cleaning in pure water, and air-dried, whereby a film-attached glass substrate 1 was obtained.

### Example 2

A film-attached glass substrate 1 was obtained in the same manner as in Example 1 except that the PTMS content ratio was changed to 0.6.

### Example 3

A film-attached glass substrate 1 was obtained in the same manner as in Example 1 except that the PTMS content ratio was changed to 0.4.

### Example 4

A film-attached glass substrate 1 was obtained in the same manner as in Example 1 except that the PTMS content ratio was changed to 1.0 (i.e., the TEOS content ratio was 0%).

### Example 5

A film-attached glass substrate 1 was obtained in the same manner as in Example 1 except that the PTMS content ratio was changed to 0.2.

### Example 6

A film-attached glass substrate 1 was obtained in the same manner as in Example 1 except that the PTMS content ratio was changed to 0 (i.e., the TEOS content ratio was 100%).

### Example 7

A glass substrate was obtained in the same manner as in Example 1 except that no film 5 was formed.

The manufacturing conditions of each Example have been described above.

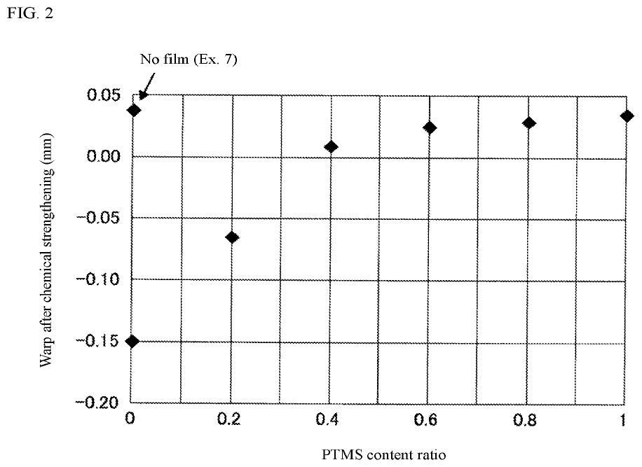

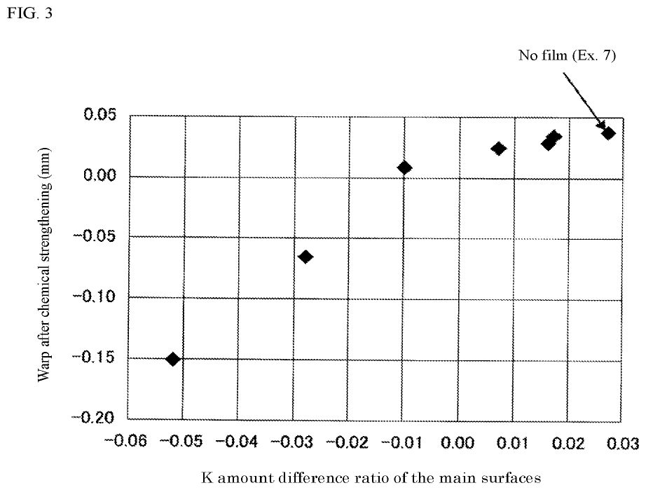

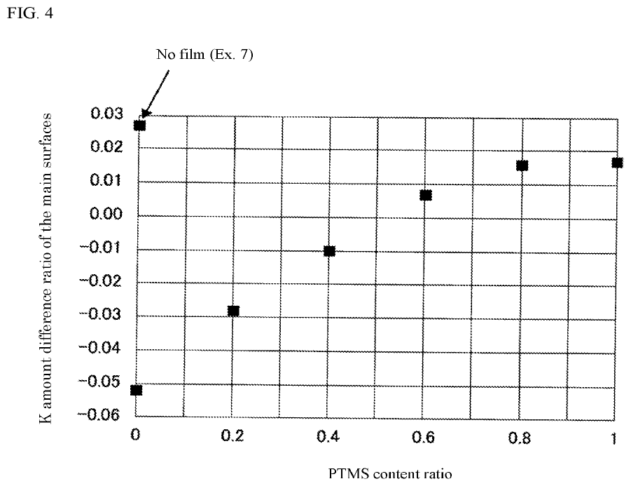

Measurement and evaluation results of each Example are shown in Table 1. FIG. 2 shows a relationship between the PTMS content ratio and the warp that was determined from Table 1. FIG. 3 shows a relationship between the K amount difference ratio of the main surfaces and the warp that was determined from Table 1. FIG. 4 shows a relationship between the PTMS content ratio and the K amount difference ratio of the main surfaces that was determined from Table 1. Measurement results of K amounts of the films of Examples 1-6 were 1 at % or larger.

TABLE 1

| | | K amount | Warp after | | | | | | | | Surface |
|---|---|---|---|---|---|---|---|---|---|---|---|
| | | difference | chemical | | | 60° | Variable angle photometer | | | Pencil | roughness |
| | PTRS | ratio of | strengthening | Finger- | Hz | gloss | Clarity | Diffusion | | hardness | Ra |
| Sample No. | content ratio | main surfaces | mm | print | Ave. | Ave. | (transmission) | (reflection) | Glare | (reflection) | (μm) |
| Ex. 1 | 0.8 | 0.016 | 0.029 | None | 63.7 | 12 | 0.26 | 0.96 | 29 | ≥6H | 0.44 |
| Ex. 2 | 0.6 | 0.007 | 0.025 | None | 59.8 | 13 | 0.43 | 0.95 | 30 | ≥6H | 0.42 |
| Ex. 3 | 0.4 | −0.010 | 0.009 | None | 59.3 | 12 | 0.46 | 0.95 | 31 | ≥6H | 0.41 |
| Ex. 4 | 1.0 | 0.017 | 0.035 | Present | 47.1 | 14 | 0.28 | 0.95 | 39 | ≥6H | 0.38 |
| Ex. 5 | 0.2 | −0.028 | −0.065 | None | 54.1 | 13 | 0.57 | 0.93 | 34 | ≥6H | 0.36 |
| Ex. 6 | 0 | −0.052 | −0.150 | None | 63.6 | 13 | 0.60 | 0.97 | 33 | ≥6H | 0.36 |
| Ex. 7 | 0 (no film) | 0.027 | 0.038 | — | — | — | — | — | — | — | — |

Whereas the film-attached glass substrate 1 in each of Examples 5 and 6 having the PTMS content ratio smaller than 0.3 warped largely in the opposite direction, the film-attached glass substrate 1 in each of Examples 1-4 having the PTMS content ratio of 0.3 or larger had the K amount difference ratio of the main surfaces smaller than in Examples 5 and 6 and had warp smaller than in Examples 5, 6, and 7. In Examples 1-3 in which the K amount difference ratio of the main surfaces was in a range of −0.016 to 0.016, the warp was small, no fingerprint was found, and the haze ratio, 60° specular glossiness, diffusion, glare, reflection, and Ra were all good. Examples 2 and 3 in which the K amount difference ratio of the main surfaces was in a range of −0.015 to 0.015 were also good in clarity.

It has been found from the above results that when the PTMS content ratio is 0.3 or larger, even in the case where chemical strengthening is performed after formation of the film 5, the warp due to the chemical strengthening can be made smaller than in a case where the film 5 is not formed.

Furthermore, it has been found that a preferable range of the PTMS content ratio is 0.4 to 0.8.

Although the present invention has been described in detail by referring to the particular embodiment, it is apparent to those skilled in the art that various changes and modifications can be applied without departing from the spirit and scope of the present invention

The present application is based on Japanese Patent Application No. 2017-089543 filed on Apr. 28, 2017, the contents of which are incorporated herein by reference.

### DESCRIPTION OF SYMBOLS

1 . . . Film-attached glass substrate;
3 . . . Glass substrate;
5 . . . Film;
17, 19 . . . Compressive stress layer;
21, 23 . . . Main surface.

1. A film-attached glass substrate comprising:
a glass substrate comprising two main surfaces each comprising a compressive stress layer; and
a film that is formed on one of the two main surfaces of the glass substrate and comprises 1 at % or larger of K, wherein
the film is an antiglare film, and
the two main surfaces have a K amount difference ratio of the compressive stress layers of the main surfaces, that is given by Relation (1) shown below, being in a range of −0.027 to 0.027:
(K amount difference ratio of compressive stress layers of main surfaces)={(K amount of first main surface)−(K amount of second main surface)}/[{(K amount of first main surface)+(K amount of second main surface)}/2] (1),
wherein the first main surface is a main surface on which the film is formed, the second main surface is a main surface on which the film is not formed, and the K amount means a value obtained by subtracting, from a value obtained by accumulating K counts, in a thickness direction, of a layer having a certain thickness including the compressive stress layer using an EPMA (electron probe microanalyzer), a value obtained by accumulating K counts of a portion that has a same thickness as the layer having the certain thickness including the compressive stress layer and has no compressive stress layer formed therein.

2. The film-attached glass substrate according to claim 1, wherein the two main surfaces have the K amount difference ratio of the compressive stress layers of the main surfaces given by Relation (1) being in a range of −0.02 to 0.02.

3. The film-attached glass substrate according to claim 1, wherein the film comprises a silica-based matrix comprising 50 mass % or larger of a silica.

4. An article comprising the film-attached glass substrate according to claim 1.

5. A method for manufacturing a film-attached glass substrate, the method comprising steps of:
applying a coating liquid to one of two main surfaces of a glass substrate by an electrostatic coating; and
obtaining a film-attached glass substrate by chemically strengthening the glass substrate to which the coating liquid has been applied, wherein
the coating liquid comprises, at a proportion that satisfies Relation (2) shown below, a silica precursor (A) comprising a silane compound excluding a trialkoxysilane having an alkyl group having a carbon number of 3 or larger and 10 or smaller, and/or comprising a hydrolytic condensate thereof, and a silica precursor (B) comprising a trialkoxysilane having an alkyl group having a carbon number of 3 or larger and 10 or smaller, and/or comprising a hydrolytic condensate thereof, and
a sum of a content of the silica precursor (A) and a content of the silica precursor (B) in terms of an SiO₂-converted concentration with respect to a content of solids in terms of oxides in the coating liquid is 50 mass % or larger:
(silica precursor (B) (mol))/{(silica precursor (A) (mol))+(silica precursor (B) (mol))}≥0.3 (2).

6. The method for manufacturing a film-attached glass substrate according to claim 5, wherein the silica precursor (A) is a tetraalkoxysilane and/or a hydrolytic condensate thereof.

7. The method for manufacturing a film-attached glass substrate according to claim 6, wherein the silica precursor (A) is at least one substance selected from the group consisting of a tetramethoxysilane, a tetraethoxysilane, a tetrapropoxysilane, a tetrabuthoxysilane, and their hydrolytic condensates.

8. The method for manufacturing a film-attached glass substrate according to claim 5, wherein the silica precursor (B) is at least one substance selected from the group consisting of a propyltrimethoxysilane, a propyltriethoxysilane, a hexyltrimethoxysilane, an octyltriethoxysilane, a decyltrimethoxysilane, and their hydrolytic condensates.
